(19) United States
(12) Patent Application Publication
(10) Pub. No.: US 2026/0045162 A1
(43) Pub. Date: Feb. 12, 2026

(54) REINFORCEMENT LEARNING (RL)-BASED TRAFFIC SIGNAL CONTROL (TSC) METHOD AND APPARATUS, DEVICE, MEDIUM, AND PRODUCT

(71) Applicant: The Hong Kong University of Science and Technology (Guangzhou), Guangzhou (CN)

(72) Inventors: Hui Xiong, Guangzhou (CN); Qian Sun, Guangzhou (CN)

(21) Appl. No.: 19/294,445

(22) Filed: Aug. 8, 2025

(30) Foreign Application Priority Data
Aug. 8, 2024 (CN) 202411080776.9

(51) Int. Cl. G08G 1/083; G06N 3/0455; G06N 3/092; G08G 1/01; G08G 1/08

(52) U.S. Cl. CPC G08G 1/083; G06N 3/0455; G06N 3/092; G08G 1/0129; G08G 1/0133; G08G 1/0145; G08G 1/08

(57) ABSTRACT

Provided are a reinforcement learning (RL)-based traffic signal control (TSC) method and apparatus, a device, a medium, and a product. The TSC method includes: obtaining traffic state data of a target intersection at a current time point and a road network graph, where the traffic state data includes a quantity of lanes at the target intersection and a traffic flow of each of the lanes; inputting the traffic state data and the road network graph into a preset traffic signal prediction model, and obtaining a target phase action output by the traffic signal prediction model, where the traffic signal prediction model includes a spatiotemporal encoder and a return-based action decoder, and the traffic signal prediction model is obtained through training based on return-based contrastive learning; and controlling, based on the target phase action, a traffic light at the target intersection to execute the target phase action.

### CROSS-REFERENCE TO RELATED APPLICATIONS

The present application claims the benefit of Chinese Patent Application No. 202411080776.9 filed on Aug. 8, 2024, the contents of which are hereby incorporated by reference.

### TECHNICAL FIELD

The present disclosure relates to the technical field of traffic signal control (TSC), and in particular, to a reinforcement learning (RL)-based TSC method and apparatus, a device, a medium, and a product.

### BACKGROUND

Traffic signal control (TSC) alleviates congestion at an urban intersection by optimizing traffic flows from different directions. With the advancement of machine learning technologies, a reinforcement learning (RL)-based TSC method has been widely studied. However, existing TSC methods have following drawbacks: An online RL method requires extensive exploration in a real environment, which may cause serious traffic congestion or accident risks during model training. In addition, poor model performance at an exploration stage leads to inefficiency and instability in practical deployment, limiting application of the online RL method in actual signal light control. Although an offline RL method can avoid a risk of real-time interaction, its performance may not be as good as performance of the online RL method in some cases due to a lack of iterative optimization of data distribution. For example, Behavior Cloning, conservative Q-learning, and other offline RL methods may not achieve an optimal control effect when dealing with a complex traffic flow pattern. A sequence modeling-based TSC method has demonstrated competitive performance by predicting an action based on historical trajectory data, but is still deficient in capturing a dynamic spatial dependency between data samples from different intersections. As a result, a complex correlation between traffic signals fails to be fully utilized, potentially resulting in a suboptimal control effect.

### SUMMARY

A technical problem to be solved in the present disclosure is to provide an RL-based TSC method and apparatus, a device, a medium, and a product. Offline learning, sequence modeling, and spatiotemporal dependency modeling are combined to capture a dynamic spatial dependency between traffic signals and fully utilize a complex correlation between intersections, thereby effectively improving overall performance of TSC.

To achieve the foregoing objective, the embodiments of the present disclosure provide an RL-based TSC method, including:
obtaining traffic state data of a target intersection at a current time point and a road network graph, where the traffic state data includes a quantity of lanes at the target intersection and a traffic flow of each of the lanes;
inputting the traffic state data and the road network graph into a preset traffic signal prediction model, and obtaining a target phase action output by the traffic signal prediction model, where the traffic signal prediction model includes a spatiotemporal encoder and a return-based action decoder, and the traffic signal prediction model is obtained through training based on return-based contrastive learning; and
controlling, based on the target phase action, a traffic light at the target intersection to execute the target phase action.

As an improvement to the above solution, a training process of the traffic signal prediction model includes:
obtaining historical traffic state data of the target intersection, and generating a historical trajectory sequence of each traffic signal, where the historical trajectory sequence includes a state sequence, an action sequence, and a return sequence;
inputting the historical trajectory sequence and the road network graph into the spatiotemporal encoder, and obtaining a spatiotemporally enhanced representation output by the spatiotemporal encoder;
inputting the spatiotemporally enhanced representation into the return-based action decoder, and obtaining a phase action output by the return-based action decoder; and
determining an optimization objective through the return-based contrastive learning, performing iterative training, and obtaining a trained traffic signal prediction model.

As an improvement to the above solution, the spatiotemporal encoder includes a token representation module and a dual spatiotemporal aggregation module, and the inputting the historical trajectory sequence and the road network graph into the spatiotemporal encoder, and obtaining a spatiotemporally enhanced representation output by the spatiotemporal encoder specifically includes:
inputting the state sequence into a first fully connected layer of the token representation module, and obtaining a state token representation of the state sequence;
inputting the action sequence into a second fully connected layer of the token representation module, and obtaining an action token representation of the action sequence;
for the return sequence, introducing a lane-level self-attention mechanism, inputting features of a plurality of lanes at the target intersection into a self-attention unit of the token representation module as basic tokens to obtain a lane-level representation, aggregating the lane-level representation, and obtaining a return token representation of the return sequence; and
inputting the state token representation, the action token representation, the return token representation, and the road network graph into the dual spatiotemporal aggregation module, and obtaining the spatiotemporally enhanced representation output by the dual spatiotemporal aggregation module.

As an improvement to the above solution, the dual spatiotemporal aggregation module includes a spatial encoder and a temporal encoder, and the inputting the state token representation, the action token representation, the return token representation, and the road network graph into the dual spatiotemporal aggregation module, and obtaining the spatiotemporally enhanced representation output by the dual spatiotemporal aggregation module specifically includes:
inputting the state token representation, the action token representation, the return token representation, and the road network graph into the spatial encoder, learning a spatial dependency between different traffic signals through the spatial encoder, and obtaining a spatially enhanced representation;
inputting the state token representation, the action token representation, the return token representation, and the road network graph into the temporal encoder, learning a temporal dependency between different time steps of each traffic signal through the temporal encoder, and obtaining a temporally enhanced representation; and
integrating the spatially enhanced representation and the temporally enhanced representation through a gating mechanism, and obtaining the spatiotemporally enhanced representation.

As an improvement to the above solution, the spatiotemporally enhanced representation includes a spatiotemporally enhanced state representation, action representation, and return representation, and the inputting the spatiotemporally enhanced representation into the return-based action decoder, and obtaining a phase action output by the return-based action decoder specifically includes:
separately encoding the return representation into the state representation and the action representation, and generating an encoded trajectory sequence; and
inputting the encoded trajectory sequence into a causal decoder, performing prediction autoregressively based on a causal self-attention mask, and obtaining a predicted phase action.

As an improvement to the above solution, the determining an optimization objective through the return-based contrastive learning, performing iterative training, and obtaining a trained traffic signal prediction model particularly includes:
constructing a corresponding positive sample and negative sample for an anchor return token;
classifying the positive sample and the negative sample by using a binary classification discriminator, and determining a binary cross-entropy loss; and
using the binary cross-entropy loss and a cross-entropy loss as optimization objectives of the traffic signal prediction model, performing the iterative training until a preset stopping condition is met, and obtaining the trained traffic signal prediction model.

The embodiments of the present disclosure further provide an RL-based TSC apparatus, including:
a data obtaining module configured to obtain traffic state data of a target intersection at a current time point and a road network graph, where the traffic state data includes a quantity of lanes at the target intersection and a traffic flow of each of the lanes;
an action prediction module configured to input the traffic state data and the road network graph into a preset traffic signal prediction model, and obtain a target phase action output by the traffic signal prediction model, where the traffic signal prediction model includes a spatiotemporal encoder and a return-based action decoder, and the traffic signal prediction model is obtained through training based on return-based contrastive learning; and
a signal control module configured to control, based on the target phase action, a traffic light at the target intersection to execute the target phase action.

The embodiments of the present disclosure further provide a terminal device, including: a processor, a memory, and a computer program stored in the memory and configured to be executed by the processor, where the processor executes the computer program to implement the RL-based TSC method in any one of the above embodiments.

The embodiments of the present disclosure further provide a non-transitory computer-readable storage medium, where the non-transitory computer-readable storage medium includes a stored computer program, and the computer program is run to control a device at which the non-transitory computer-readable storage medium is located to execute the RL-based TSC method in any one of the above embodiments.

The embodiments of the present disclosure further provide a computer program product, where the computer program product includes a non-transitory computer-readable storage medium that contains computer-readable program code, and the computer-readable program code is executable to enable a computer to implement the RL-based TSC method in any one of the above embodiments.

Compared with the prior art, an RL-based TSC method and apparatus, a device, a medium, and a product provided in the embodiments of the present disclosure achieve following beneficial effects: Traffic state data of a target intersection at a current time point and a road network graph are obtained, where the traffic state data includes a quantity of lanes at the target intersection and a traffic flow of each of the lanes; the traffic state data and the road network graph are inputted into a preset traffic signal prediction model, and a target phase action output by the traffic signal prediction model is obtained, where the traffic signal prediction model includes a spatiotemporal encoder and a return-based action decoder, and the traffic signal prediction model is obtained through training based on return-based contrastive learning; and based on the target phase action, a traffic light at the target intersection is controlled to execute the target phase action. By combining offline learning, sequence modeling, and spatiotemporal dependency modeling, the embodiments of the present disclosure capture a dynamic spatial dependency between traffic signals and fully utilize a complex correlation between intersections, thereby effectively improving overall performance of TSC.

### BRIEF DESCRIPTION OF THE DRAWINGS

FIG. 1 is a schematic flowchart of an RL-based TSC method according to a preferred embodiment of the present disclosure;

FIG. 2 is a phase diagram of traffic light control in an RL-based TSC method according to the present disclosure;

FIG. 3 schematically shows a framework of a traffic signal prediction model in an RL-based TSC method according to the present disclosure;

FIG. 4 is a schematic structural diagram of an RL-based TSC apparatus according to a preferred embodiment of the present disclosure; and

FIG. 5 is a schematic structural diagram of a terminal device according to a preferred embodiment of the present disclosure.

### DETAILED DESCRIPTION

The technical solutions of the embodiments of the present disclosure are clearly and completely described below with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

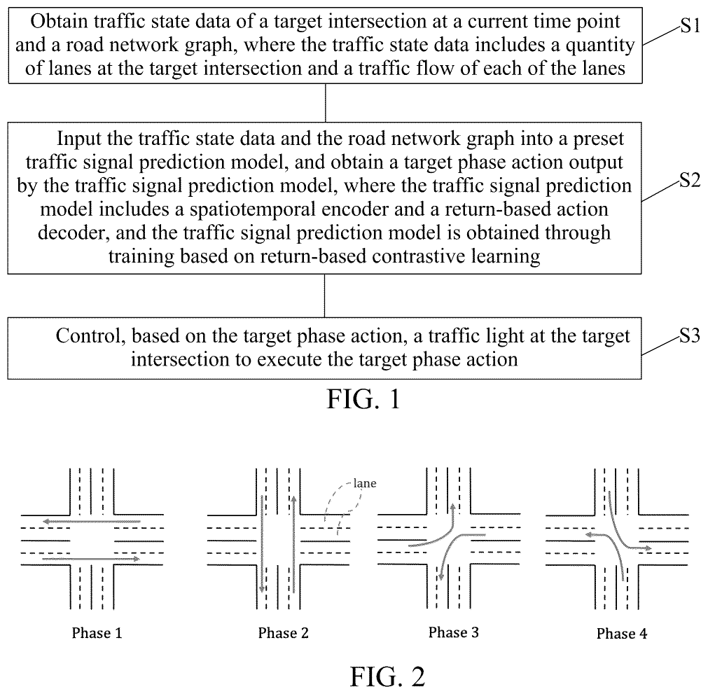

FIG. 1 is a schematic flowchart of an RL-based TSC method according to a preferred embodiment of the present disclosure. The RL-based TSC method includes:
S1: Obtain traffic state data of a target intersection at a current time point and a road network graph, where the traffic state data includes a quantity of lanes at the target intersection and a traffic flow of each of the lanes.
S2: Input the traffic state data and the road network graph into a preset traffic signal prediction model, and obtain a target phase action output by the traffic signal prediction model, where the traffic signal prediction model includes a spatiotemporal encoder and a return-based action decoder, and the traffic signal prediction model is obtained through training based on return-based contrastive learning.
S3: Control, based on the target phase action, a traffic light at the target intersection to execute the target phase action.

Specifically, in this embodiment of the present disclosure, a phase change of the traffic light is studied in a TSC task. FIG. 2 is a phase diagram of traffic light control in the RL-based TSC method according to the present disclosure. In a green phase, traffic in a specific direction is allowed to proceed within a specific time interval. There are two signal light control strategies: controlling a sequence of the green phase when fixed duration of each phase is determined, and determining time to switch to a next phase on a basis of maintaining a predefined sequence of the green phase. The two strategies aim to reduce congestion at an intersection. The RL-based TSC method provided in this embodiment of the present disclosure obtains the traffic state data of the target intersection at the current time point and the road network graph. The traffic state data includes the quantity of lanes at the target intersection and the traffic flow of each of the lanes. The traffic flow further includes state data of a vehicle. The traffic state data and the road network graph are inputted into the preset trained traffic signal prediction model, and the target phase action output by the traffic signal prediction model is obtained. In this embodiment of the present disclosure, the traffic signal prediction model includes the spatiotemporal encoder, the return-based action decoder, and the return-based contrastive learning. The spatiotemporal encoder is configured to obtain spatiotemporally enhanced representations of a state, an action, and a return. The return-based action decoder is configured to predict the action in a causal manner. The return-based contrastive learning enhances a capability of the model in distinguishing a data sample into a specific auxiliary task, and each task reflects a unique traffic flow pattern. After the target phase action output by the traffic signal prediction model is obtained, based on the target phase action, the traffic light at the target intersection is controlled to execute the target phase action.

This embodiment of the present disclosure adopts an offline learning method, thereby avoiding an exploration risk in online RL and reducing a possibility of traffic congestion or accidents during actual deployment. In addition, offline learning improves efficiency and stability of model training. A spatiotemporal sequence modeling technique is utilized, and an offline RL strategy is improved, such that an excellent control effect can still be achieved under different traffic flow patterns. This makes up for a deficiency of a traditional offline learning method in dealing with a complex traffic environment, and can better capture a dynamic spatial dependency between traffic signals, fully utilize a complex correlation between intersections, and effectively improve overall performance of TSC. A return-based contrastive learning mechanism enhances an adaptive capability of the model in different types of traffic flow patterns. In this way, the model can automatically adjust a control strategy as a traffic flow pattern changes, thereby ensuring excellent performance in various traffic scenarios. This embodiment of the present disclosure provides a stable and efficient traffic management solution, which effectively optimizes urban TSC, enhances overall traffic flow efficiency, meets demands of complex traffic environments in modern cities, and demonstrates broad practical applications.

In another preferred embodiment, a training process of the traffic signal prediction model includes:
S10: Obtain historical traffic state data of the target intersection, and generate a historical trajectory sequence of each traffic signal, where the historical trajectory sequence includes a state sequence, an action sequence, and a return sequence.
S20: Input the historical trajectory sequence and the road network graph into the spatiotemporal encoder, and obtain a spatiotemporally enhanced representation output by the spatiotemporal encoder.
S30: Input the spatiotemporally enhanced representation into the return-based action decoder, and obtain a phase action output by the return-based action decoder.
S40: Determine an optimization objective through the return-based contrastive learning, perform iterative training, and obtain a trained traffic signal prediction model.

Specifically, in RL, an environment can be modeled as a Markov decision process (MDP), which is defined by a tuple (S, A, P, R, γ). In the tuple, S represents a state space, A represents an action space, P represents a transition probability matrix, and R and γ respectively represent a reward function and a reward discount factor. For RL-based TSC, the state space S is composed of traffic features of different incoming and outgoing lanes at the target intersection, such as an average speed and a traffic flow. The action space A determines duration of a current phase in a case that a fixed phase plan is given, or selects an index of a next green phase while considering shortest duration of the green phase. The reward function R includes congestion indicators such as a total queue length, average travel time (ATT), and average waiting time in an incoming direction.

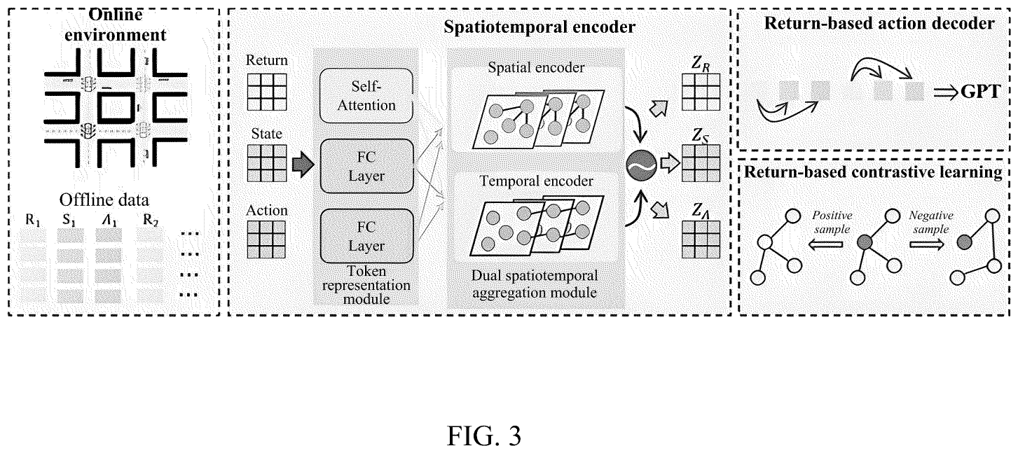

FIG. 3 schematically shows a framework of the traffic signal prediction model in the RL-based TSC method according to the present disclosure. In this embodiment of the present disclosure, an offline TSC problem can be formulized as follows: An offline dataset (namely historical traffic state data) collected from each intersection and the road network graph G∈R^{N×N} are given, where N represents a total quantity of traffic signals, and R represents a real number set. Historical trajectory sequences represented by a global construct are generated: R∈ R^{K×N×L}, S∈R^{K×N×D}, and A∈R^{K×N×1}, where K represents a length of a trajectory sequence, L represents a quantity of lanes at each intersection, and D represents a feature space dimension of the state. Based on historical trajectory sequences (R₁, S₁, A₁, . . . , Rₜ, Sₜ) of all traffic lights, the model is trained to fit the phase action Aₜ autoregressively. The historical trajectory sequence and the road network graph are inputted into the spatiotemporal encoder, and the spatiotemporally enhanced representation output by the spatiotemporal encoder is obtained. The spatiotemporally enhanced representation is inputted into the return-based action decoder, and the phase action output by the return-based action decoder is obtained. The optimization objective is determined through the return-based contrastive learning, the iterative training is performed, and the trained traffic signal prediction model is obtained. For example, during model evaluation, the model is forced to predict an optimal phase action based on a maximum possible target return (namely, R=0). Based on the above inputs, this embodiment of the present disclosure is intended to consider dynamic interaction between signals, so as to predict an optimal action for the traffic signal.

In still another preferred embodiment, the spatiotemporal encoder includes a token representation module and a dual spatiotemporal aggregation module, and the S20 in which the historical trajectory sequence and the road network graph is inputted into the spatiotemporal encoder, and the spatiotemporally enhanced representation output by the spatiotemporal encoder is obtained specifically includes:
S201: Input the state sequence into a first fully connected layer of the token representation module, and obtain a state token representation of the state sequence.
S202: Input the action sequence into a second fully connected layer of the token representation module, and obtain an action token representation of the action sequence.
S203: For the return sequence, introduce a lane-level self-attention mechanism, input features of a plurality of lanes at the target intersection into a self-attention unit of the token representation module as basic tokens to obtain a lane-level representation, aggregate the lane-level representation, and obtain a return token representation of the return sequence.
S204: Input the state token representation, the action token representation, the return token representation, and the road network graph into the dual spatiotemporal aggregation module, and obtain the spatiotemporally enhanced representation output by the dual spatiotemporal aggregation module.

Specifically, in this embodiment of the present disclosure, the spatiotemporal encoder includes the token representation module and the dual spatiotemporal aggregation module. The token representation module is configured to encode an input token. The dual spatiotemporal aggregation module is configured to capture dynamic and inter-signal dependencies in an embedding. Considering different dimensions of heterogeneous input tokens, this embodiment of the present disclosure maps these tokens into a unified representation space. The state sequence is inputted into the first fully connected layer ƒₛ(·) of the token representation module, and the state token representation of the state sequence is obtained. The action sequence is inputted into the second fully connected layer ƒ_{α}(·) of the token representation module, and the action token representation of the action sequence is obtained. For example, for the state sequence and the action sequence, the fully connected layer ƒₛ(·) and the fully connected layer ƒ_{α}(·) are respectively used to generate feature representation vectors Hₛ∈ [symbol] ^{K×N×d} and H_{A}∈ [symbol] ^{K×N×d} of the state sequence and the action sequence, where d represents a dimension of a feature vector space. For the return sequence, the prior art directly applies a Vanilla neural network to a return of each intersection and ignores an inherent correlation between different lanes. In order to provide a more effective and comprehensive return representation, this embodiment of the present disclosure introduces the lane-level self-attention mechanism that adaptively combines features of different lanes. The features of the plurality of lanes at the target intersection are inputted into the self-attention unit of the token representation module as the basic tokens, the lane-level representation is aggregated, and the return token representation of the return sequence is obtained. For example, a feature of a lane is represented as follows:

$${\hat{R}}_{i , j , k} = MultiHeadAtt ( {R}_{i , j , k} {W}_{Q}^{R} , {R}_{i , j , k} {W}_{K}^{R} , {R}_{i , j , k} {W}_{V}^{R} ) .$$

As described above, an input R_{i,j,k} represents a traffic feature of a k^{th} lane at a j^{th} intersection at an i^{th} time step; and matrices W_{Q}, W_{K}, and W_{V}∈ [symbol] ^{1×d} represent learnable parameters. On this basis, this embodiment of the present disclosure further aggregates the lane-level representation to obtain the return token representation. For example, a pooling operation is applied to all lanes at a single intersection, and the return token representation is as follows:

$${H}_{i , j}^{R} ← Pooling ( {\hat{R}}_{i , j , 1} , … , {\hat{R}}_{i , j , L} ) .$$

As described above, \hat{R}_{i,j,L} represents a traffic feature of an L^{th} lane.

After each type of token is mapped into a unified embedding space, each token is modeled in both spatial and temporal dimensions. The state token representation, the action token representation, the return token representation, and the road network graph are inputted into the dual spatiotemporal aggregation module, and the spatiotemporally enhanced representation output by the dual spatiotemporal aggregation module is obtained.

In still another preferred embodiment, the dual spatiotemporal aggregation module includes a spatial encoder and a temporal encoder, and the S204 in which the state token representation, the action token representation, the return token representation, and the road network graph are inputted into the dual spatiotemporal aggregation module, and the spatiotemporally enhanced representation output by the dual spatiotemporal aggregation module is obtained specifically includes:
S214: Input the state token representation, the action token representation, the return token representation, and the road network graph into the spatial encoder, learn a spatial dependency between different traffic signals through the spatial encoder, and obtain a spatially enhanced representation.
S224: Input the state token representation, the action token representation, the return token representation, and the road network graph into the temporal encoder, learn a temporal dependency between different time steps of each traffic signal through the temporal encoder, and obtain a temporally enhanced representation.
S234: Integrate the spatially enhanced representation and the temporally enhanced representation through a gating mechanism, and obtain the spatiotemporally enhanced representation.

Specifically, in this embodiment of the present disclosure, the dual spatiotemporal aggregation module includes the spatial encoder and the temporal encoder. The spatial encoder is configured to capture a spatial correlation between tokens of different traffic signals, and the temporal encoder is configured to capture temporal dynamics of traffic patterns at different time steps. The state token representation, the action token representation, the return token representation, and the road network graph are inputted into the spatial encoder, the spatial dependency between the different traffic signals is obtained through the spatial encoder, and the spatially enhanced representation is obtained. The state token representation, the action token representation, the return token representation, and the road network graph are inputted into the temporal encoder, the temporal dependency between the different time steps of each traffic signal is obtained through the temporal encoder, and the temporally enhanced representation is obtained. The spatially enhanced representation and the temporally enhanced representation are integrated through the gating mechanism, and the spatiotemporally enhanced representation is obtained.

For example, the following provides a detailed description of the return token representation H_{R}, and same processing is performed on the state token representation H_{S} and the action token representation H_{A}.

In a traditional method, a graph neural network (GNN) such as a graph convolutional network (GCN) is used to capture an inherent spatial pattern and association on a predefined road network. However, because the GNN is primarily good at modeling local topological information, relying directly on an adjacency relationship between nodes (namely traffic lights) may not fully capture a spatial correlation between the traffic signals. Therefore, this embodiment of the present disclosure adopts a transformer-like architecture to process the return representation from a spatial perspective without introducing an additional inductive bias. In this embodiment of the present disclosure, one learnable spatial position code is introduced for each token type. For the return token, a code is represented as P_{R}^{S}∈ [symbol] ^{N×N}, which is initialized based on a road network adjacency matrix. Subsequently, the code is consistently connected to a hidden token representation at each time step. At this stage, in order to maintain a unified dimension, a subsequent linear layer is applied. Formally, a spatial position awareness return representation can be obtained according to

$${H}_{R}^{S} = {f}_{S} ( {H}_{R} ‖ {P}_{R}^{S} ) ,$$

where ƒ_{S}(·) represents a fully connected layer, and ∥ represents a connection operation. Along this direction, this embodiment of the present disclosure further utilizes a spatially guided multi-head attention (MHA) mechanism and residual connection to capture a potential spatial dependency between different traffic signals.

$${Z}_{R}^{S} = MHA ( {H}_{R}^{S} ) + {H}_{R}^{S} .$$

In addition to capturing the spatial correlation between the traffic signals, it is also crucial to capture the temporal dynamics of the traffic patterns at the different time steps. Similar to the spatial encoder described earlier, one temporal position embedding is allocated to each token type, which is represented as a matrix P_{R}^{T}∈ [symbol] ^{K×K} and initialized through one-hot embedding of a discrete time step. Subsequently, the code is consistently connected to the hidden token representation at each node (namely, each traffic light). A temporal position awareness return representation can be achieved in this embodiment of the present disclosure, which is expressed as follows:

$${H}_{R}^{T} = {f}_{T} ( {H}_{R} ‖ {P}_{R}^{T} ) ,$$

where ƒ_{T} represents a linear mapping function. At this stage, this embodiment of the present disclosure further utilizes a temporally guided MHA mechanism and residual connection to capture a potential temporal dependency between different time steps of each traffic signal, as shown below:

$${Z}_{R}^{T} = MHA ( {H}_{R}^{T} ) + {H}_{R}^{T} .$$

Up to now, the temporally enhanced representation

$${Z}_{R}^{T}$$

and the spatially enhanced representation

$${Z}_{R}^{S}$$

have been learned. In order to promote multi-source information integration, this embodiment of the present disclosure designs the gating mechanism that integrates a hidden embedding in the spatial and temporal dimensions. Specifically, this embodiment of the present disclosure considers spatial and temporal representations to control the gating mechanism, thereby achieving context-aware fusion of two information sources. Formally, this process can be formulized as follows:

$$g = σ ( {W}_{S} \cdot {Z}_{R}^{S} + {W}_{T} \cdot {Z}_{R}^{T} ) , {Z}_{R} = g ⊙ {Z}_{R}^{S} + ( 1 - g ) ⊙ {Z}_{R}^{T} ,$$

As described above, σ represents a sigmoid activation function, W_{S}∈ [symbol] ^{d×d} and W_{T}∈ [symbol] ^{d×d} represent two learnable parameters, and (represents element-level multiplication.

In still another preferred embodiment, the spatiotemporally enhanced representation includes a spatiotemporally enhanced state representation, action representation, and return representation, and the S30 in which the spatiotemporally enhanced representation is inputted into the return-based action decoder, and the phase action output by the return-based action decoder is obtained specifically includes:
S301: Separately encode the return representation into the state representation and the action representation, and generate an encoded trajectory sequence.
S302: Input the trajectory sequence into a causal decoder, perform prediction autoregressively based on a causal self-attention mask, and obtain a predicted phase action.

Specifically, the spatiotemporally enhanced representation in this embodiment of the present disclosure includes the spatiotemporally enhanced state representation, action representation, and return representation. After the spatiotemporally enhanced state representation, action representation, and return representation are obtained through the spatiotemporal encoder, the causal decoder is used to predict a next action. In order to effectively “index” state and action representations based on the return, this embodiment of the present disclosure combines a return-based embedding subspace transformation scheme to transform input data into different subspaces within an input dimension. Specifically, for each time step, this embodiment of the present disclosure separately encodes the return representation Z_{R} into the state representation and the action representation. This process can be formulized as [symbol] =Z_{S}⊙Z_{R} and [symbol] =Z_{A}⊙Z_{R}, where ⊙ represents an element-level product of two vectors. In this way, the representations [symbol] and [symbol] that are encoded based on the return can be used as inputs of the causal decoder to predict an action token. Therefore, the input trajectory sequence is transformed into a following structure:

$$τ = ( {\tilde{z}}_{S}^{1} , {\tilde{z}}_{A}^{1} , {\tilde{z}}_{S}^{2} , {\tilde{z}}_{A}^{2} , … , {\tilde{z}}_{S}^{t + 1} ) .$$

Subsequently, a reconstructed trajectory sequence is inputted into the causal decoder, the prediction is performed autoregressively based on the causal self-attention mask, and the predicted phase action is obtained.

For example, this embodiment of the present disclosure replaces softmax with the first m tokens in the trajectory to generate a following prediction:

$${p}_{A}^{t + i} = TransformerDecoder ( ( {\tilde{z}}_{S}^{1} , {\tilde{z}}_{A}^{1} , {\tilde{z}}_{S}^{2} , {\tilde{z}}_{A}^{2} , … , {\tilde{z}}_{S}^{t + 1} ) ) .$$

In still another preferred embodiment, the S40 in which the optimization objective is determined through the return-based contrastive learning, the iterative training is performed, and the trained traffic signal prediction model is obtained specifically includes:
S401: Construct a corresponding positive sample and negative sample for a specific anchor return token.
S402: Classify the positive sample and the negative sample by using a binary classification discriminator, and determine a binary cross-entropy loss.
S403: Use the binary cross-entropy loss and a cross-entropy loss as optimization objectives of the traffic signal prediction model, perform the iterative training until a preset stopping condition is met, and obtain the trained traffic signal prediction model.

Specifically, because this embodiment of the present disclosure formulizes a task as a return-based action prediction task, this embodiment of the present disclosure further designs an auxiliary task to contrastively enhance distinguishability of the return representation. Specifically, if the specific anchor return token (namely, an anchor) is given, this embodiment of the present disclosure employs two data augmentation techniques to obtain the corresponding positive sample and negative sample. The positive sample is represented as R⁺. This embodiment of the present disclosure uses a constant (for example, 0) to mask an input feature of an anchor return. In order to generate the negative sample R⁻, this embodiment of the present disclosure processes each time step separately and performs row-by-row randomization on a feature matrix within the time step. Therefore, for each anchor return token, there is exactly one positive sample and one negative sample. Then, this embodiment of the present disclosure uses the binary classification discriminator D: [symbol] ^{d}× [symbol] ^{d}→[0,1] to classify an anchor-positive sample pair and an anchor-negative sample pair. This embodiment of the present disclosure further utilizes the binary cross-entropy loss to optimize a contrastive learning process:

$${ℒ}_{c} = - ( y log ( σ ( f ( R , {R}^{+} ) ) ) + ( 1 - y ) log ( 1 - σ ( f ( R , {R}^{-} ) ) ) ) .$$

As described above, a represents the sigmoid activation function, and γ represents a token inputted in a paired manner. A goal of this design is to encourage the model to model a topological gap and enable the model to recognize a random graph structure, thereby enhancing a capability of the model in recognizing a spatial pattern. Because a true value of the action includes four traffic phases shown in FIG. 2, this embodiment of the present disclosure formulizes a prediction task as a classification problem. Therefore, this embodiment of the present disclosure adopts the cross-entropy loss as the optimization objective, which is defined as follows:

$${ℒ}_{P} = - {\sum }_{i = 1}^{C} {p}_{A}^{t + 1} log ( {a}^{t + 1} )$$

As described above, C represents a quantity of phases,

$${p}_{A}^{t + 1}$$

represents a predicted value, and α^{t+1} represents a true phase value.

Therefore, a final loss function of the traffic signal prediction model is as follows:

$$ℒ = {ℒ}_{p} + α * {ℒ}_{c} .$$

As described above, α controls weights of two loss functions.

The binary cross-entropy loss and the cross-entropy loss as the optimization objectives of the traffic signal prediction model, the iterative training is performed until the preset stopping condition is met (for example, when the value of the final loss function reaches a preset threshold), and the trained traffic signal prediction model is obtained.

For example, the embodiments of the present disclosure evaluate performance of an STLight model (namely, the traffic signal prediction model) in the embodiments of the present disclosure on two public real-world datasets, namely a Hangzhou 4×4 road network (4 rows horizontally and 4 columns vertically) and a Jinan 3×4 road network (3 rows horizontally and 4 columns vertically), with a total of 16 traffic signals and 12 traffic signals respectively. In order to obtain offline data, the embodiments of the present disclosure train a state-of-the-art RL-based TSC model named AdvancedCilight, and save state, action, and return trajectories at each time step. In addition, the embodiments of the present disclosure iteratively create a slice with a sequence length of K=4 to preprocess a long trajectory. During the model evaluation, the embodiments of the present disclosure use a traffic simulator CityFlow as an environment for real-time traffic simulation. Each training/evaluation epoch lasts for 3600 seconds, while green time for each possible phase lasts for 15 seconds. The embodiments of the present disclosure train all models for 100 epochs, and conduct online evaluation once every 10 epochs. An evaluation result shows an average value of the last 5 evaluation epochs.

The embodiments of the present invention compare the STLight with three types of benchmark methods:
Heuristic method: As a classic rule-based method, MaxPressure selects a phase based on pressure of queuing vehicles in different incoming and outgoing directions.
Online RL: Colight and the AdvancedCollight are multi-agent deep Q-network (DQN) models and are used for a graph attention network (GAT) that aggregates neighbor information.
Offline RL: Behavior Cloning is a type of imitation learning baseline and reproduces an action by using a given state as an input. A Decision Transformer is a sequence modeling-based method and predicts an action autoregressively based on a return and a state of a historical trajectory. DataLight is an offline RL model with conservative Q-learning. TransformerLight uses a gate-controlled transformer to predict a phase action of a causal signal.

In terms of evaluation indicators, the embodiments of the present disclosure select three commonly-used evaluation indicators in the TSC task, including an average queue length (AQL), average pressure (AP), and the ATT.

The embodiments of the present disclosure show comparative analysis performed on the STLight model and the benchmark methods in Table 1. A result indicates that the STLight outperforms the competitive methods on both the Hangzhou 4×4 dataset and the Jinan 3×4 dataset. Specifically, offline models such as the Decision Transformer and the TransformerLight eliminate a need for online exploration but maintain competitive performance, which validates effectiveness of a transition from an online RL-based TSC method to offline modeling. Among these offline methods, the model in the embodiments of the present disclosure decreases the AQL by 7.2% compared with the best-performing DataLight model on the Hangzhou dataset. This highlights significance of the sequence modeling and capturing of a sequence dependency of the MDP, as the DataLight performs learning from an individual token of the MDP rather than a sequence. In addition, compared with the offline sequence modeling method TransformerLight, which is also adapted from the Decision Transformer, the method in the embodiments of the present disclosure decreases the AQL and the AP by 3.0% and 4.56% respectively on the Jinan 3×4 dataset, indicating effectiveness of spatiotemporal sequence modeling in the TSC task. Overall, the experimental results indicate that the model in the embodiments of the present disclosure outperforms state-of-the-art benchmark models in the TSC task.

TABLE 1
Performance comparison of models

| | Hangzhou-4x4 | | | Jinan-3x4 | | |
|---|---|---|---|---|---|---|
| Algorithm | AQL | AP | ATT | AQL | AP | ATT |
| MaxPressure | 40.3 | 13.5 | 291.6 | 223.4 | 74.6 | 276.2 |
| CoLight | 38.6 | 12.3 | 290.0 | 214.0 | 71.5 | 271.9 |
| AdvancedCoLight | 24.5 | 9.4 | 272.5 | 152.9 | 48.8 | 247.4 |
| BehaviorCloning | 26.4 | 9.7 | 279.2 | 159.3 | 52.1 | 249.5 |
| DecisionTransformer | 25.3 | 9.7 | 275.4 | 159.1 | 50.5 | 252.6 |
| DataLight | 23.5 | 9.2 | 272.3 | 154.5 | 49.9 | 249.0 |
| TransformerLight | 24.5 | 9.5 | 273.3 | 155.2 | 50.4 | 249.2 |
| STLight | 21.8 | 8.1 | 270.5 | 150.4 | 48.1 | 245.8 |

Correspondingly, the present disclosure further provides an RL-based TSC apparatus, which can implement all procedures of the RL-based TSC method in the above embodiments.

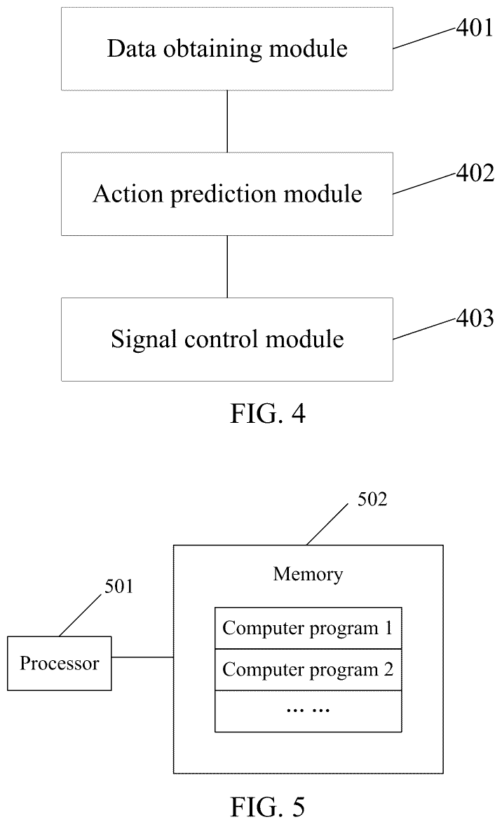

FIG. 4 is a schematic structural diagram of an RL-based TSC apparatus according to a preferred embodiment of the present disclosure. The RL-based TSC apparatus includes:
a data obtaining module 401 configured to obtain traffic state data of a target intersection at a current time point and a road network graph, where the traffic state data includes a quantity of lanes at the target intersection and a traffic flow of each of the lanes;
an action prediction module 402 configured to input the traffic state data and the road network graph into a preset traffic signal prediction model, and obtain a target phase action output by the traffic signal prediction model, where the traffic signal prediction model includes a spatiotemporal encoder and a return-based action decoder, and the traffic signal prediction model is obtained through training based on return-based contrastive learning; and
a signal control module 403 configured to control, based on the target phase action, a traffic light at the target intersection to execute the target phase action.

Preferably, a training process of the traffic signal prediction model includes:
obtaining historical traffic state data of the target different intersection, and generating a historical trajectory sequence of each traffic signal, where the historical trajectory sequence includes a state sequence, an action sequence, and a return sequence;
inputting the historical trajectory sequence and the road network graph into the spatiotemporal encoder, and obtaining a spatiotemporally enhanced representation output by the spatiotemporal encoder;
inputting the spatiotemporally enhanced representation into the return-based action decoder, and obtaining a phase action output by the return-based action decoder; and
determining an optimization objective through the return-based contrastive learning, performing iterative training, and obtaining a trained traffic signal prediction model.

Preferably, the spatiotemporal encoder includes a token representation module and a dual spatiotemporal aggregation module, and the inputting the historical trajectory sequence and the road network graph into the spatiotemporal encoder, and obtaining a spatiotemporally enhanced representation output by the spatiotemporal encoder specifically includes:
inputting the state sequence into a first fully connected layer of the token representation module, and obtaining a state token representation of the state sequence;
inputting the action sequence into a second fully connected layer of the token representation module, and obtaining an action token representation of the action sequence;
for the return sequence, introducing a lane-level self-attention mechanism, inputting features of a plurality of lanes at the target intersection into a self-attention unit of the token representation module as basic tokens to obtain a lane-level representation, aggregating the lane-level representation, and obtaining a return token representation of the return sequence; and
inputting the state token representation, the action token representation, the return token representation, and the road network graph into the dual spatiotemporal aggregation module, and obtaining the spatiotemporally enhanced representation output by the dual spatiotemporal aggregation module.

Preferably, the dual spatiotemporal aggregation module includes a spatial encoder and a temporal encoder, and the inputting the state token representation, the action token representation, the return token representation, and the road network graph into the dual spatiotemporal aggregation module, and obtaining the spatiotemporally enhanced representation output by the dual spatiotemporal aggregation module specifically includes:
inputting the state token representation, the action token representation, the return token representation, and the road network graph into the spatial encoder, learning a spatial dependency between different traffic signals through the spatial encoder, and obtaining a spatially enhanced representation;
inputting the state token representation, the action token representation, the return token representation, and the road network graph into the temporal encoder, learning a temporal dependency between different time steps of each traffic signal through the temporal encoder, and obtaining a temporally enhanced representation; and
integrating the spatially enhanced representation and the temporally enhanced representation through a gating mechanism, and obtaining the spatiotemporally enhanced representation.

Preferably, the spatiotemporally enhanced representation includes a spatiotemporally enhanced state representation, action representation, and return representation, and the inputting the spatiotemporally enhanced representation into the return-based action decoder, and obtaining a phase action output by the return-based action decoder specifically includes:
separately encoding the return representation into the state representation and the action representation, and generating an encoded trajectory sequence; and
inputting the encoded trajectory sequence into a causal decoder, performing prediction autoregressively based on a causal self-attention mask, and obtaining a predicted phase action.

Preferably, the determining an optimization objective through the return-based contrastive learning, performing iterative training, and obtaining a trained traffic signal prediction model specifically includes:
constructing a corresponding positive sample and negative sample for a specific anchor return token;
classifying the positive sample and the negative sample by using a binary classification discriminator, and determining a binary cross-entropy loss; and
using the binary cross-entropy loss and a cross-entropy loss as optimization objectives of the traffic signal prediction model, performing the iterative training until a preset stopping condition is met, and obtaining the trained traffic signal prediction model.

In specific implementation, the RL-based TSC apparatus in this embodiment of the present disclosure has a same working principle, control flow, and technical effect as the RL-based TSC method in the above embodiments. Details are not described herein again.

In the embodiments of the present disclosure, the RL-based TSC apparatus includes a processor and a memory. The processor is configured to execute the following program modules and program units stored in the memory: the data obtaining module 401, the action prediction module 402, the signal control module 403, the token representation module, the dual spatiotemporal aggregation module, and the self-attention unit.

FIG. 5 is a schematic structural diagram of a terminal device according to a preferred embodiment of the present disclosure. The terminal device includes a processor 501, a memory 502, and a computer program stored in the memory 502 and configured to be executed by the processor 501. The processor 501 executes the computer program to implement the RL-based TSC method in any one of the above embodiments.

Preferably, the computer program may be divided into at least one module/unit (for example, a computer program 1, and a computer program 2). The at least one module/unit is stored in the memory 502 and executed by the processor 501 to achieve the present disclosure. The at least one module/unit may be a series of computer program instruction segments capable of implementing specific functions, and the instruction segments are used for describing an execution process of the computer program in the terminal device.

The processor 501 may be a central processing unit (CPU), and may also be another general-purpose processor, a digital signal processor (DSP), an application specific integrated circuit (ASIC), a field-programmable gate array (FPGA) or another programmable logic device, a discrete gate or transistor logic device, a discrete hardware component, or the like. The general-purpose processor may be a microprocessor. Alternatively, the processor 501 may also be any conventional processor. The processor 501 is a control center of the terminal device, which connects various parts of the terminal device by using various interfaces and wires.

The memory 502 mainly includes a program storage area and a data storage area. The program storage area may store an operating system, an application program required for at least one function, and the like. The data storage area may store related data and the like. In addition, the memory 502 may be a high-speed random access memory (RAM), and may further be a non-volatile memory, such as a plug-in hard disk, a smart media card (SMC), a secure digital (SD) card, or a flash card. Alternatively, the memory 502 may be another volatile solid-state storage device.

It should be noted that the terminal device may include, but is not limited to, a processor and a memory. Those skilled in the art should understand that the schematic structural diagram in FIG. 5 is only an example of the terminal device, and does not constitute a limitation on the terminal device. The terminal device may include more or fewer components than those shown in the figure, or a combination of certain components, or different components.

The embodiments of the present disclosure further provide a non-transitory computer-readable storage medium. The non-transitory computer-readable storage medium includes a stored computer program, and the computer program is run to control a device at which the non-transitory computer-readable storage medium is located to execute the RL-based TSC method in any one of the above embodiments.

The embodiments of the present disclosure further provide a computer program product. The computer program product includes a non-transitory computer-readable storage medium that contains computer-readable program code, and the computer-readable program code is executable to enable a computer to implement the RL-based TSC method in any one of the above embodiments.

The embodiments of the present disclosure provide an RL-based TSC method and apparatus, a device, a medium, and a product. Traffic state data of a target intersection at a current time point and a road network graph are obtained, where the traffic state data includes a quantity of lanes at the target intersection and a traffic flow of each of the lanes. The traffic state data and the road network graph are inputted into a preset traffic signal prediction model, and a target phase action output by the traffic signal prediction model is obtained, where the traffic signal prediction model includes a spatiotemporal encoder and a return-based action decoder, and the traffic signal prediction model is obtained through training based on return-based contrastive learning. Based on the target phase action, a traffic light at the target intersection is controlled to execute the target phase action. By combining offline learning, sequence modeling, and spatiotemporal dependency modeling, the embodiments of the present disclosure capture a dynamic spatial dependency between traffic signals and fully utilize a complex correlation between intersections, thereby effectively improving overall performance of TSC.

It should be noted that the apparatus embodiments described above are merely examples, where units described as separate components may or may not be physically separated. Components displayed as units may or may not be physical units, that is, the components may be located in one place, or may be distributed to a plurality of network units. Some or all of the modules may be selected based on actual needs to achieve the objectives of the solutions of the embodiments. In addition, in the accompanying drawings of the apparatus embodiments provided in the present disclosure, a connection relationship between modules represents a communication connection between the modules, which may be specifically implemented as at least one communication bus or signal line. Those of ordinary skill in the art can understand and implement the embodiments without creative effort.

The descriptions above are preferred implementations of the present disclosure. It should be noted that for a person of ordinary skill in the art, various improvements and modifications can be made without departing from the principles of the present disclosure. These improvements and modifications should also be regarded as falling into the protection scope of the present disclosure.

1. A reinforcement learning (RL)-based traffic signal control (TSC) method, comprising:
obtaining traffic state data of a target intersection at a current time point and a road network graph, wherein the traffic state data comprises a quantity of lanes at the target intersection and a traffic flow of each of the lanes;
inputting the traffic state data and the road network graph into a preset traffic signal prediction model, and obtaining a target phase action output by the traffic signal prediction model, wherein the traffic signal prediction model comprises a spatiotemporal encoder and a return-based action decoder, and the traffic signal prediction model is obtained through training based on return-based contrastive learning; and
controlling, based on the target phase action, a traffic light at the target intersection to execute the target phase action.

2. The RL-based TSC method according to claim 1, wherein a training process of the traffic signal prediction model comprises:
obtaining historical traffic state data of the target intersection, and generating a historical trajectory sequence of each traffic signal, wherein the historical trajectory sequence comprises a state sequence, an action sequence, and a return sequence;
inputting the historical trajectory sequence and the road network graph into the spatiotemporal encoder, and obtaining a spatiotemporally enhanced representation output by the spatiotemporal encoder;
inputting the spatiotemporally enhanced representation into the return-based action decoder, and obtaining a phase action output by the return-based action decoder; and
determining an optimization objective through the return-based contrastive learning, performing iterative training, and obtaining a trained traffic signal prediction model.

3. The RL-based TSC method according to claim 2, wherein the spatiotemporal encoder comprises a token representation module and a dual spatiotemporal aggregation module, and the inputting the historical trajectory sequence and the road network graph into the spatiotemporal encoder, and obtaining a spatiotemporally enhanced representation output by the spatiotemporal encoder specifically comprises:
inputting the state sequence into a first fully connected layer of the token representation module, and obtaining a state token representation of the state sequence;
inputting the action sequence into a second fully connected layer of the token representation module, and obtaining an action token representation of the action sequence;
for the return sequence, introducing a lane-level self-attention mechanism, inputting features of a plurality of lanes at the target intersection into a self-attention unit of the token representation module as basic tokens to obtain a lane-level representation, aggregating the lane-level representation, and obtaining a return token representation of the return sequence; and
inputting the state token representation, the action token representation, the return token representation, and the road network graph into the dual spatiotemporal aggregation module, and obtaining the spatiotemporally enhanced representation output by the dual spatiotemporal aggregation module.

4. The RL-based TSC method according to claim 3, wherein the dual spatiotemporal aggregation module comprises a spatial encoder and a temporal encoder, and the inputting the state token representation, the action token representation, the return token representation, and the road network graph into the dual spatiotemporal aggregation module, and obtaining the spatiotemporally enhanced representation output by the dual spatiotemporal aggregation module specifically comprises:
inputting the state token representation, the action token representation, the return token representation, and the road network graph into the spatial encoder, learning a spatial dependency between different traffic signals through the spatial encoder, and obtaining a spatially enhanced representation;
inputting the state token representation, the action token representation, the return token representation, and the road network graph into the temporal encoder, learning a temporal dependency between different time steps of each traffic signal through the temporal encoder, and obtaining a temporally enhanced representation; and
integrating the spatially enhanced representation and the temporally enhanced representation through a gating mechanism, and obtaining the spatiotemporally enhanced representation.

5. The RL-based TSC method according to claim 2, wherein the spatiotemporally enhanced representation comprises a spatiotemporally enhanced state representation, action representation, and return representation, and the inputting the spatiotemporally enhanced representation into the return-based action decoder, and obtaining a phase action output by the return-based action decoder specifically comprises:
separately encoding the return representation into the state representation and the action representation, and generating an encoded trajectory sequence; and
inputting the encoded trajectory sequence into a causal decoder, performing prediction autoregressively based on a causal self-attention mask, and obtaining a predicted phase action.

6. The RL-based TSC method according to claim 2, wherein the determining an optimization objective through the return-based contrastive learning, performing iterative training, and obtaining a trained traffic signal prediction model specifically comprises:
constructing a corresponding positive sample and negative sample for an anchor return token;
classifying the positive sample and the negative sample by using a binary classification discriminator, and determining a binary cross-entropy loss; and
using the binary cross-entropy loss and a cross-entropy loss as optimization objectives of the traffic signal prediction model, performing the iterative training until a preset stopping condition is met, and obtaining the trained traffic signal prediction model.

7. An RL-based TSC apparatus, comprising:
a data obtaining module configured to obtain traffic state data of a target intersection at a current time point and a road network graph, wherein the traffic state data comprises a quantity of lanes at the target intersection and a traffic flow of each of the lanes;
an action prediction module configured to input the traffic state data and the road network graph into a preset traffic signal prediction model, and obtain a target phase action output by the traffic signal prediction model, wherein the traffic signal prediction model comprises a spatiotemporal encoder and a return-based action decoder, and the traffic signal prediction model is obtained through training based on return-based contrastive learning; and
a signal control module configured to control, based on the target phase action, a traffic light at the target intersection to execute the target phase action.

8. A terminal device, comprising: a processor and a memory, wherein the memory stores a computer program, the computer program is configured to be executed by the processor, and the processor executes the computer program to implement the RL-based TSC method according to claim 1.

9. A terminal device, comprising: a processor and a memory, wherein the memory stores a computer program, the computer program is configured to be executed by the processor, and the processor executes the computer program to implement the RL-based TSC method according to claim 2.

10. A terminal device, comprising: a processor and a memory, wherein the memory stores a computer program, the computer program is configured to be executed by the processor, and the processor executes the computer program to implement the RL-based TSC method according to claim 3.

11. A terminal device, comprising: a processor and a memory, wherein the memory stores a computer program, the computer program is configured to be executed by the processor, and the processor executes the computer program to implement the RL-based TSC method according to claim 4.

12. A terminal device, comprising: a processor and a memory, wherein the memory stores a computer program, the computer program is configured to be executed by the processor, and the processor executes the computer program to implement the RL-based TSC method according to claim 5.

13. A terminal device, comprising: a processor and a memory, wherein the memory stores a computer program, the computer program is configured to be executed by the processor, and the processor executes the computer program to implement the RL-based TSC method according to claim 6.

14. A non-transitory computer-readable storage medium, wherein the non-transitory computer-readable storage medium stores a computer program, and a device at which the non-transitory computer-readable storage medium is located executes the computer program to implement the RL-based TSC method according to claim 1.

15. A non-transitory computer-readable storage medium, wherein the non-transitory computer-readable storage medium stores a computer program, and a device at which the non-transitory computer-readable storage medium is located executes the computer program to implement the RL-based TSC method according to claim 2.

16. A non-transitory computer-readable storage medium, wherein the non-transitory computer-readable storage medium stores a computer program, and a device at which the non-transitory computer-readable storage medium is located executes the computer program to implement the RL-based TSC method according to claim 3.

17. A non-transitory computer-readable storage medium, wherein the non-transitory computer-readable storage medium stores a computer program, and a device at which the non-transitory computer-readable storage medium is located executes the computer program to implement the RL-based TSC method according to claim 4.

18. A non-transitory computer-readable storage medium, wherein the non-transitory computer-readable storage medium stores a computer program, and a device at which the non-transitory computer-readable storage medium is located executes the computer program to implement the RL-based TSC method according to claim 5.

19. A non-transitory computer-readable storage medium, wherein the non-transitory computer-readable storage medium stores a computer program, and a device at which the non-transitory computer-readable storage medium is located executes the computer program to implement the RL-based TSC method according to claim 6.

20. A computer program product, wherein the computer program product comprises a non-transitory computer-readable storage medium that contains computer-readable program code, and the computer-readable program code is executable to enable a computer to implement the RL-based TSC method according to claim 1.
